(19) United States
(12) Patent Application Publication
(10) Pub. No.: US 2003/0070115 A1
(43) Pub. Date: Apr. 10, 2003

(54) Logging and retrieving pre-boot error information

(76) Inventors: Tom L. Nguyen, Olympia, WA (US); Mallik Bulusu, Olympia, WA (US)

Correspondence Address: Timothy N. Trop, TROP, PRUNER & HU, P.C., 8554 KATY FWY, STE 100, HOUSTON, TX, 77024-1805, US

(21) Appl. No.: 09/971,825

(22) Filed: Oct. 5, 2001

(51) Int. Cl. H04L 1/22

(52) U.S. Cl. 714/23

(57) ABSTRACT

A number of correctable and uncorrectable errors, including machine check aborts and system-hang events, may occur during the pre-boot stage prior to operation of an operating system. Outside of a laboratory environment, for example, in the field, it is very difficult to obtain this error information. By logging the error information during the pre-boot stage, the logged error information may thereafter be transferred to an appropriate media or over a ii network for subsequent analysis. This pre-boot logging and subsequent retrieval may enable correction of pre-boot errors that otherwise may go unanalyzed and repeatedly reoccur.

### BACKGROUND

This invention relates generally to the basic input/output system.

Before the operating system is called, the basic input/output system (BIOS) is responsible for initializing and booting the processor-based system. Once the BIOS has completed it tasks, it transfers control to the operating system.

The BIOS may include at least three different levels. The lowest level may be the processor abstraction layer (PAL) that communicates with the hardware and particularly the processor. A middle layer is called the system abstraction layer (SAL). The SAL may attempt to correct correctable errors after they are detected and reported to the PAL. The uppermost layer, called the extensible firmware interface (EFI), communicates with the operating system and, in fact, launches the operating system.

When an error occurs, the error can be corrected or reported via handlers. A handler is a software module that handles errors by directing errors that are detected to an appropriate entity such as the operating system, the EFI, the SAL, or whatever. Thus, the handler directs the error to an entity that may or may not be able to correct the error.

Errors that are handled by the operating system may initially come to the initialization handler. The initialization handler ascribes the error to the operating system for handling and the operating system may then resolve the error or report the error to the user.

Some errors occur before the operating system is booted. The pre-boot stage is the stage before the operating system is called and the post-boot stage is the stage after the operating system is called. Errors that are detected during post-boot may be readily reported to the user using well-established protocols. However, errors that occur during the pre-boot stage are not readily reportable to the user. In a laboratory setting, there are tools for determining information about pre-boot errors. For example, an in-target probe is a processor-based system that may be utilized to diagnose errors on other processor-based systems. However, such tools are generally not available outside of the laboratory environment.

In general, two types of errors may occur during the pre-boot condition. A machine check abort error is an error that is reported by a processor or a particular platform. Thus, machine check errors, or MCAs, are either chipset or processor specific. In either case, they generally amount to hardware based errors. The other type of error is a system-hang event that is basically software based.

Pre-boot system failures often occur during BIOS or chipset design and implementation stages and they may be frequently reported from various customers to processor, BIOS or chipset designers. The only error information that may be accessed, in some cases, in the field is derived from the post-code port 80h. The processor executes code and then automatically updates the port 80h. The port 80h then reports milestones that have been actually executed by the BIOS. Each time a major milestone is completed, it is automatically updated at port 80h. Intermediate milestones may be reported at port 81h. A post-code call may be utilized to read the value at a port 80h or 81h.

Unfortunately, populating the post-code port 80h on every system is not desirable because of the associated costs and the limited amount of information that can be gleaned. In-house diagnostic tools, such as in-target probes, usually require the processor minimal state and platform error logging records for analyzing system pre-boot failures. Generally, therefore, pre-boot failures are not obtainable by users in the field. As a result, errors may go unanalyzed and may, therefore, continue to reoccur.

Thus, there is a need for better ways to analyze pre-boot errors.

### BRIEF DESCRIPTION OF THE DRAWINGS

FIG. 1 is a schematic depiction of one embodiment of the present invention;

FIG. 2 is a schematic depiction of a processor-based system, also shown in FIG. 1, in accordance with one embodiment of the present invention;

FIG. 3 is a flow chart for pre-boot error logging software in accordance with one embodiment of the present invention;

FIG. 4 is a flow chart for post-boot software that operates with the pre-boot software shown in FIG. 3 in accordance with one embodiment of the present invention;

FIG. 5 is a schematic depiction of the logging of pre-boot errors in accordance with one embodiment of the present invention; and

FIG. 6 is a flow chart for the logging of pre-boot errors in accordance with another embodiment of the present invention.

### DETAILED DESCRIPTION

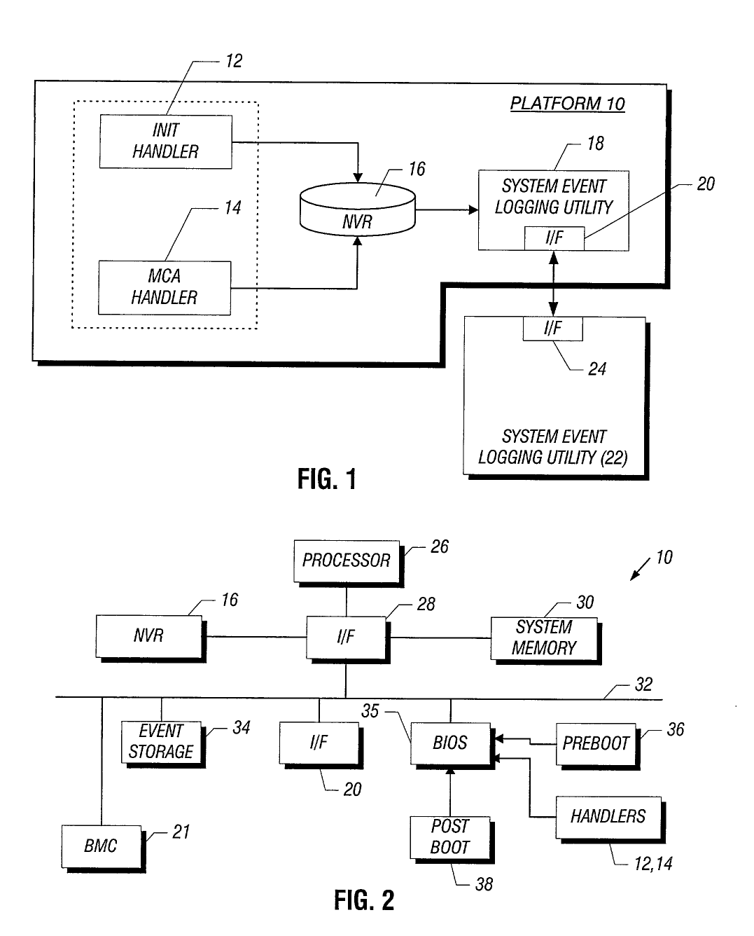

Referring to FIG. 1, a platform 10 may be any processor-based system including a server, a desktop computer, a laptop computer, a portable computer, or a handheld device, to mention a few examples. The platform 10 may include a nonvolatile storage area (NVR) 16. The storage area 16 may receive error information from an initialization handler 12 and a machine check abort handler 14. The initialization handler 12 generally handles system-hang events and the machine check abort handler 14 generally handles machine check aborts from either the processor or the platform.

The NVR 16 may ultimately be read by a system event logging utility 18 after the pre-boot is over. The logging utility 18 may extract the error information from the NVR 16 and provide it, via an interface 20, to a system event logging utility 22 that is external to the platform 10. Thus, the error information may be transferred from the interface 20 to the interface 24 and eventually to the utility 22.

The utility 22 may include a recording medium, such as a magnetic high-density memory to record the error data in one embodiment. Suitable memories for this purpose include the LS-120 and LS-240 memories. As another example, the interface 20 may be a network interface that provides the information over a computer network to a network utility 22.

Errors that occur during the pre-boot stage may be logged and subsequently, in the post-boot stage, extracted to a recording medium in appropriate circumstances. The error information may be stored on an appropriate magnetic media in some embodiments. The magnetic media may be transferred to an appropriate laboratory for analysis. As a result, errors that occur during the pre-boot stage may be analyzed and identified. Thus, for particular platforms 10, these errors may be corrected and, in some cases, the designs may be adjusted to avoid those errors in the future.

Referring to FIG. 2, in accordance with one embodiment of the present invention, the platform 10 may include a processor 26 coupled to an interface or bridge 28. The bridge 28 may be coupled to the NVR 16 and the system memory 30, in one embodiment. The interface 28 is also coupled to a bus 32. The bus 32 may be coupled to another interface 20 as well as event storage 34 and a basic input/output system (BIOS) storage 35. The BIOS storage 35 may store the BIOS including the pre-boot software 36 that handles the logging of errors that occur during the pre-boot stage and the post-boot software 38 that facilitates reporting the errors after the operating system has taken over control. A plurality of handlers 12 and 14 may also be stored in connection with the BIOS storage 35.

Finally, in some embodiments, a baseboard management controller (BMC) 21 may also be coupled to the bus 32. The BMC 21 is a controller that may be responsible for facilitating automatic network communications with the platform 10. The BMC 21 is effectively a processor or a controller used for system management purposes. For example, the BMC 21 may be utilized to wake up a platform 10 (such as a server) through a local area network (LAN). Thus, in embodiments using the BMC 21, the interface 20 may be a network interface such as a network interface card.

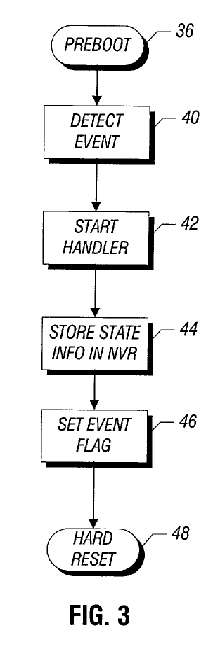

Turning next to FIG. 3, the pre-boot software 36 initially detects an error event, as indicated in block 40. The error event may, in some embodiments, be a machine check abort from the processor 26 or the platform 10, or it may be a software error and particularly a system-hang event. When the error event is detected, the appropriate handler is initialized, as indicated in block 42. Generally, the initialization handler 12 handles software errors and the MCA handler 14 handles machine check aborts from the processor 26 or platform 10. The handler 12 or 14 logs the processor minimal state as well as the platform state into the NVR 16, as indicated in block 44. In the case of a system-hang event, the handler 12 determines the nature of the event and then logs the appropriate information into the NVR 16. After the information has been logged, a historical event flag is stored into a specific memory location, such as the event storage 34, as indicated in block 46. Thereafter, a hard reset may be generated, as indicated in block 48.

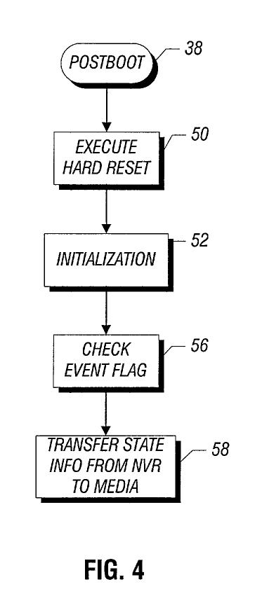

Referring to FIG. 4, after the hard reset, the post-boot software 38 may be implemented. Upon execution of the hard reset, as indicated in block 50, a minimal memory and chipset initialization may occur as indicated in block 52. The initialization need only be sufficient to enable logged errors to be appropriately reported. A check at block 56 determines whether there are any historical event flags set in the event storage 34. If so, the stored error information is transferred from the NVR 16 to an appropriate media such as a magnetic disk, as indicated in block 58.

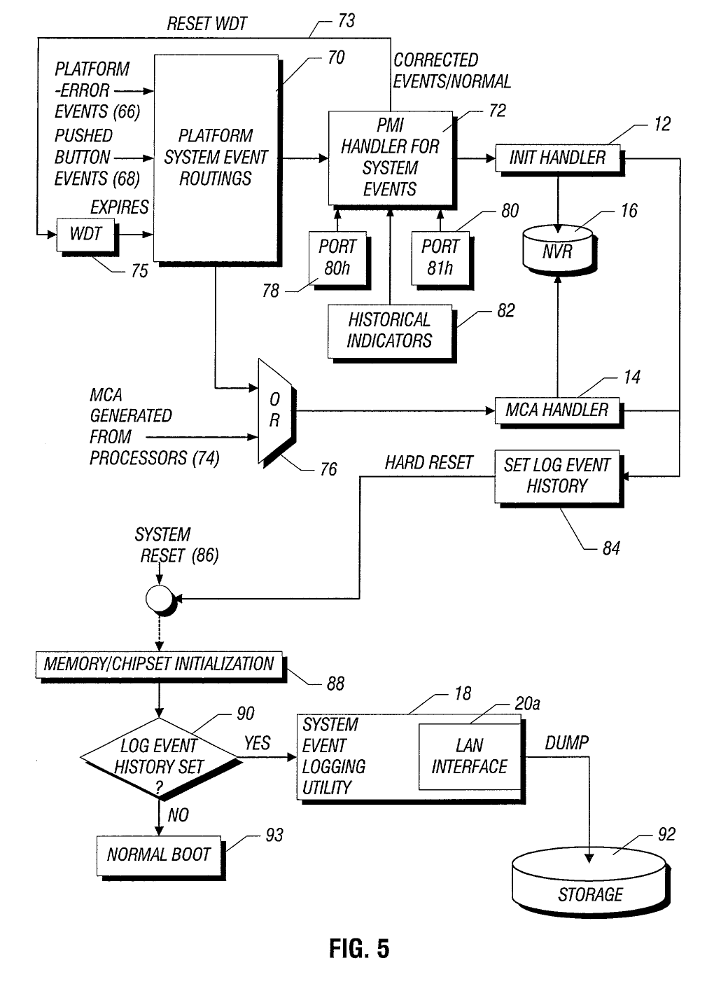

Referring to FIG. 5, the operation of the pre-boot software 36 and post-boot software 38 is illustrated in more detail in connection with a variety of potential error events, in accordance with one embodiment of the present invention. The platform system event routings 70 receive the various platform-specific errors that may occur. For example, platform errors 66 may be reported to the routing 70. In addition, events 68 that are the result of a user having pushed a button may likewise be reported to the routing 70. In addition, watchdog timer (WDT) 75 expiration may be reported to the routings 70.

The watchdog timer 75 may be operated in at least two ways in accordance with some embodiments of the present invention. In some embodiments, the watchdog timer 75 expires on relatively regular intervals. In other embodiments, the watchdog timer 75 is automatically reset each time the BIOS completes a certain task. Thus, the watchdog timer 75 only expires when a task did not get completed within the appropriate time period.

A platform specific machine check abort received by the routings 70 may be provided to an OR gate 76. The OR gate 76 also receives processor-specific machine check aborts 74. From the OR gate 76 both platform-based and processor-based machine check aborts are routed to the MCA handler 14.

The platform-based routings 70 are forwarded to a power management interrupt (PMI) handler 72 in accordance with one embodiment of the present invention. In some platforms, a power management interrupt handler 72 may be available. In other embodiments, a different handler may be utilized to handle platform-based error events. For example, in some 32-bit systems, a system management interrupt (SMI) handler may be utilized instead.

The PMI handler 72 receives information from a plurality of sources including port 80h status information. The port 80h provides the identity of the last successfully completed milestone. The port 81h provides the identity of the last successfully completed task between successive milestones (normally reported to the port 80h).

When a system-hang event occurs, it is desirable to determine what the system was doing at the time the hang event occurred and also to determine the nature of the error. Thus, current information from the ports 80h and 81h may be compared to historical indications from the historical indicators 82. The historical indicators 82 include the previous information from the port 80h and port 81h. If there is no difference between the information from the ports 78 and 80 versus the historical indicators 82, it is known that the hang event occurred after the last reported milestone or task. If there is a difference between the historical indicators 82 and the milestone or task information currently in the ports 78 and 80 respectively, it is possible to determine where in the BIOS flow the hang event occurred. This information enables the nature of the error to be determined.

Thus, in one embodiment, when the watchdog timer 75 expires without being reset, system-hang events are handled by the PMI handler 72. If possible, the PMI handler 72 corrects such errors and resets the watchdog timer 75, as indicated on path 73. Again, the handler 72 uses the port information and the historical information to determine where the hang event occurred in the sequence of BIOS operations.

Once the location of the system-hang event is determined, information about the event may be forwarded, together with the location information, to the initialization handler 12. The initialization handler 12 reports the system-hang event and the location information to the NVR 16 where it is stored during the pre-boot stage. At the same time, information about MCAs handled by the handler 14 may be similarly stored on the NVR 16.

The information stored on the NVR 16 may include the nature of the event and sufficient information to diagnose the nature of the failure, be it an MCA or a system-hang event. For example, in the case of a system-hang event, the initialization handler 12 may log the processor minimal state as well as the platform-state into the NVR 16.

After the error information has been logged on the NVR 16, the log event history flag is set in the event storage 34, as indicated in block 84. A hard reset is then initiated.

After the hard reset 86, a basic set of memory and chipset initializations may be implemented, as indicated in block 88. The extent of initializations may be only those necessary to actually transfer the logged error information to an external system, in some embodiments. Thus, a check at diamond 90 determines whether or not an event was logged in the event storage 34. If not, the system reset may have been in error and a normal boot may be initiated, as indicated in block 93. If there is a logged error event, then the utility 18 may be operated, for example, to transfer the information over a LAN interface 20a and a network to a network connected storage device 92. Of course, in other embodiments, information may be transferred to a utility 22, as described previously.

As still another embodiment, if a BMC 21 is available, the error information may be logged into the BMC 21 during pre-boot. Since the BMC 21 is its own separate processor-based system, it may be operative during both the pre-boot and the post-boot stages. A LAN already communicates through the LAN interface 20 with the BMC 21. Thus, the LAN can communicate with the BMC 21 and read the errors from the BMC 21 after the pre-boot stage.

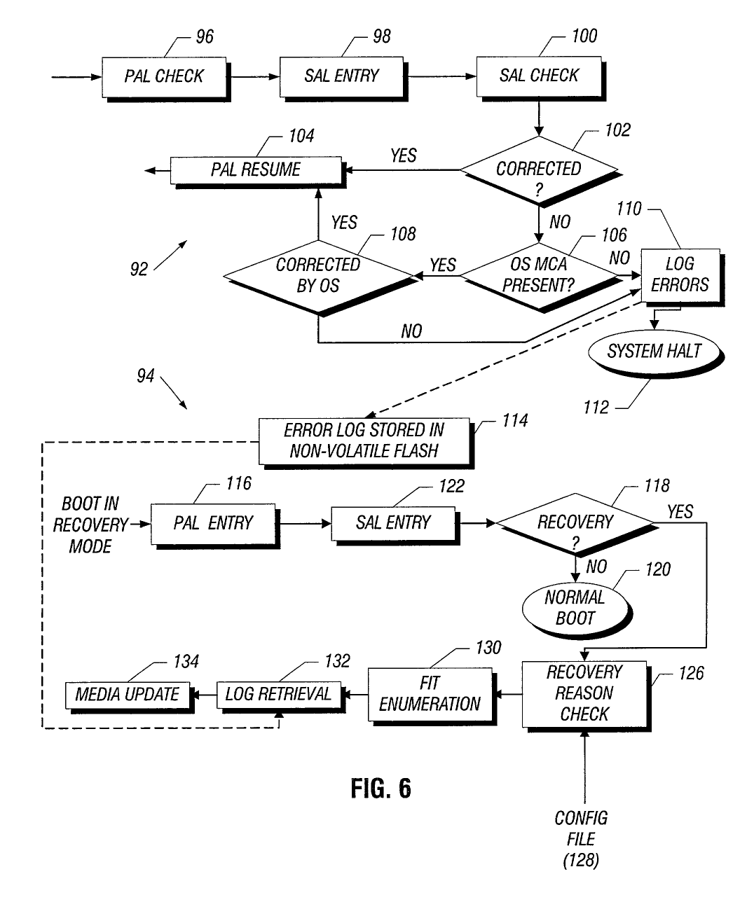

Referring to FIG. 6, in accordance with another embodiment of the present invention, uncorrectable MCAs may be logged during the pre-boot stage and then recovered during a recovery mode. During the pre-boot stage 92, an uncorrectable MCA is first handled by the PAL, as indicated in block 96. If the PAL can not handle the error, it is passed on through the SAL entry 98 to the SAL, as indicated in block 100. The SAL contains information for platform errors and is able to actually go into the platform or chipset and try to fix the error. If the SAL is successful in correcting the error, as determined at diamond 102, the PAL may resume, as indicated in block 104.

If the error can not be corrected, a check at diamond 106 determines whether an operating system MCA is present. In other words, a check at diamond 106 determines whether or not the operating system is active and, if so, the MCA is simply forwarded to the operating system handler for correction, as indicated at diamond 108. If the operating system is able to correct the error, then PAL may resume, as indicated in block 104.

If the operating system MCA is not present or, even if present, is unable to correct the error, the error is logged, as indicated in block 110 in firmware, as described previously, and the system is halted, as indicated in block 112. The error log is stored in a nonvolatile memory, such as flash memory, as indicated in block 114, and the system enters the recovery mode through the PAL entry, as indicated in block 116. The flow proceeds to the SAL entry, as indicated in block 122.

In general, the recovery mode 94 has as its purpose to program a particular memory. The BIOS may have a recovery block that is hardware locked so that it can not be corrupted. The recovery mode may include minimal code to enable a recovery in some embodiments. The recovery block may have a file system driver that can write to any part or read a file. Thus, the recovery mode may be utilized to extract the error log and to store it on appropriate memory that may be viewed after the pre-boot stage is completed.

A check at diamond 118 determines whether or not the recovery mode has been selected. If not, a normal boot occurs, as indicated in block 120. In some embodiments, the recovery mode 94 may be entered through a software or hardware setting.

At block 126, the system reads a configuration file 128, for example, from a floppy disk. The configuration file 128 includes predetermined settings that indicate what to do during the recovery mode. In some cases, the configuration file 128 may indicate to proceed with the recovery mode or it may indicate to simply read the record of the error.

If the configuration file 128 indicates that the recovery reason is to read the error record, a firmware interface table (FIT) is enumerated, as indicated in block 130. The firmware interface table enables the error log to be found in the nonvolatile memory (where it was stored in block 114) that includes many other blocks or files. Once the error files are located, the error information (block 114) may be retrieved, as indicated in block 132. The error log contents may be read and stored on appropriate media, such as the LS 120 or LS 240 magnetic media, as indicated in block 134.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
logging a fatal error during the pre-boot stage; and
extracting the logged error information during subsequent pre-boot stage.

2. The method of claim 1 wherein logging an error includes logging a system-hang event.

3. The method of claim 2 including handling a system-hang event using a power management interrupt handler.

4. The method of claim 2 including receiving information from ports 80h and 81h in order to analyze a system-hang event.

5. The method of claim 4 including receiving historical information in order to analyze a system-hang event.

6. The method of claim 3 including providing uncorrected system-hang events from the power management interrupt handler to an initialization handler.

7. The method of claim 1 wherein logging an error during the pre-boot stage includes identifying an error through the expiration of a watchdog timer.

8. The method of claim 1 including determining that an error is uncorrectable and initiating a hard reset.

9. The method of claim 8 including entering a recovery mode.

10. The method of claim 8 including determining whether an error was logged before the hard reset, and, if so, transferring the information to a system event logging utility.

11. The method of claim 8 including determining whether an error was logged before the hard reset, and, if so, transferring error information over a network interface to another processor-based system.

12. The method of claim 1 including extracting the logged error in recovery mode.

13. The method of claim 12 including obtaining information from a configuration file in order to determine whether to retrieve a logged error.

14. An article comprising a medium storing instructions that enable a processor-based system to:
log a fatal error during the pre-boot stage; and
extract the logged error information during subsequent pre-boot stage.

15. The article of claim 14 further storing instructions that enable the processor-based system to log a system-hang event.

16. The article of claim 15 further storing instructions that enable the processor-based system to handle a system-hang event using a power management interrupt handler.

17. The article of claim 15 further storing instructions that enable the processor-based system to receive information from ports 80h and 81h in order to analyze a system-hang event.

18. The article of claim 17 further storing instructions that enable the processor-based system to receive historical information in order to analyze a system-hang event.

19. The article of claim 14 further storing instructions that enable the processor-based system to log an error during the pre-boot stage to identify an error through the expiration of a watchdog timer.

20. The article of claim 14 further storing instructions that enable the processor-based system to determine that an error is uncorrectable and initiate a hard reset.

21. The article of claim 20 further storing instructions that enable the processor-based system to enter recovery mode for the purpose of error extraction.

22. The article of claim 20 further storing instructions that enable the processor-based system to determine whether an error was logged before the hard reset, and, if so, transfer the information to a system event logging utility.

23. The article of claim 20 further storing instructions that enable the processor-based system to determine whether an error was logged before the hard reset, and, if so, transfer error information over a network interface to another processor-based system.

24. A system comprising:
a processor; and
a storage coupled to said processor storing instructions that enable the processor to:
log an error during the pre-boot stage; and
extract the logged error information after the pre-boot stage is completed.

25. The system of claim 24 including a power management interrupt handler to handle a system-hang event.

26. The system of claim 25 wherein said system includes ports 80h and 81h, said ports coupled to said power management interrupt handler.

27. The system of claim 26 wherein said power management interrupt handler receives historical information in order to analyze a system-hang event.

28. The system of claim 24 including a watchdog timer to identify an error through the expiration of the watchdog timer.

29. The system of claim 24 wherein said storage stores instructions that enable the processor to determine that an error is uncorrectable and initiate a hard reset.

30. The system of claim 29 wherein said storage stores instructions that enable the processor to enter a recovery mode.

31. The system of claim 29 wherein said storage stores instructions that enable the processor to determine whether an error was logged before the hard reset, and, if so, transfer the information to a system event logging utility.

32. The system of claim 29 wherein said storage stores instructions that enable the processor to determine whether an error was logged before the hard reset, and, if so, transfer error information over a network interface to another processor-based system.

33. The system of claim 29 including a controller that is operative during the pre-boot stage to store error information.
